(19) United States
(12) Patent Application Publication
(10) Pub. No.: US 2011/0277697 A1
(43) Pub. Date: Nov. 17, 2011

(54) Animal Mobile Entertainment Device

(76) Inventors: John M. Lipscomb, Cedarburg, WI (US); Qing He, North Andover, MA (US)

(21) Appl. No.: 13/108,261

(22) Filed: May 16, 2011

Related U.S. Application Data
(60) Provisional application No. 61/334,925, filed on May 14, 2010.

(51) Int. Cl. A01K 29/00; A01K 15/02

(52) U.S. Cl. 119/708

(57) ABSTRACT

An animal mobile that includes a mount from which a boom cantilevers carrying an animal plaything with the mobile defining a spring mass system having a plurality of springs and masses that cause the plaything to unpredictably move during animal interaction. The mount is configured for door mounting having a plurality of straps that wrap around respective door knobs. The mount includes a ball and socket boom coupling arrangement that defines a spring and enables adjustable boom attachment. A drive is operated to rotate the mobile in one direction storing potential energy in at least one mobile suspension line defining another spring with the energy being released rotating the mobile in an opposite direction when the drive is caused. System feedback from interaction of the plaything by an animal, e.g., cat, causes the plaything to dance and leap in a manner simulating live prey enticing further animal interaction.

### CROSS REFERENCE TO RELATED APPLICATION

This application claims priority under 35 U.S.C. §119(e) to U.S. Provisional Patent Application No. 61/334,925, filed May 14, 2010, the entirety of which is hereby expressly incorporated by reference herein.

### FIELD

The present invention relates generally to an animal entertainment device and more particularly to an animal mobile and method of operation.

### BACKGROUND

Cats are very inquisitive by nature and, though domesticated, still possess hunting instincts that are quite acute which they often mimic in play. Since cats like to play with objects that resemble prey, many entertainment devices have been made and sold with a toy attached to a string an owner can grasp and manipulate in an effort to entice the cat to play with the toy. While such play is beneficial as it allows a cat to simulate stalking, capturing and killing prey, owners often do not have a great deal of time to play with their cats. Even when an owner has time, the cat quite often loses interest or habituates relatively quickly to the nature of the play, limiting its duration.

What is needed is an animal entertainment device that is particularly well suited for play by a cat that remains available for play even when an owner is not around or does not have time to play. What is also needed is an animal entertainment device that extends the duration of play.

### SUMMARY

The present invention is directed to an animal entertainment device that is an animal mobile having an animal plaything carried by a boom attached to a mount used to releasably mount the mobile. In a preferred mobile embodiment, the animal plaything is a first mass that is a cat toy suspended from a lower line attached to a mobile arm that is a second mass pivotally carried by an upper line extending downwardly from the boom which is attached to the mount used to releasably mount the mobile. The animal mobile is a spring mass system having a plurality of springs and masses that act together in concert when an animal interacts with the animal plaything to cause the plaything to randomly and unpredictably move in a manner that encourages further interaction.

In a preferred embodiment, the mount is a bracket configured for removable attachment to a door having a plurality of straps that wrap around door handles, door knobs, or door levers on opposite sides of the door to support the boom that cantilevers outwardly from the bracket as well as the rest of the mobile. Each strap is elongate having hook and loop fastener material on a plurality of sides of the strap with a preferred strap embodiment having one side of a hook material and an opposite side of the loop material. With the bracket disposed in engagement with the door, each strap is wrapped around a stem of a respective door handle, knob or lever at least once and preferably more than once engaging the hook and loop material of one strap layer wrapped around the stem with hook and loop material of another strap layer wrapped around the stem.

In a preferred embodiment, the door mounting bracket is generally U-shaped having a boom supporting wall with a door stile abutment surface spacing apart a pair of flanges that straddle opposite sides of the door when the abutment surface is disposed against the door stile. A plurality of pads can be disposed between each flange and a respective side of the door helping to engage the door when the bracket is mounted to the door. If desired, a pad can be disposed between the door stile abutment surface of the boom supporting wall and the door stile when the bracket is attached to the door.

The bracket includes a cradle to which one end of the boom is mounted. In a preferred embodiment the cradle is formed by a support that extends outwardly from the boom supporting wall including a socket in which the end of the boom is received. The boom can be configured with a ball at its free end forming a ball and socket boom coupling arrangement that can be adjustable to enable the position of the boom to be adjusted relative to the door and then locked in place. One of the ball and socket includes one of a plurality of channels or ribs and the other one of the ball and socket is configured for engagement of the one of the plurality of channels or ribs in a manner that retains the boom in a desired position.

In a preferred embodiment, the ball includes a plurality of circumferentially spaced apart channels and the socket includes a detent arm that is received in one of the channels to hold the boom in the desired position. Such a detent arm can be formed of a resilient finger having an outwardly extending tab that is received in a corresponding one of the channels depending upon the desired boom arm position.

The boom is further secured to the bracket by an annular coupling arrangement that includes an annular projection extending from one of the boom and cradle that is received in an annular recess formed in the other one of the boom and cradle. In a preferred embodiment, the annular coupling arrangement is formed by a pin and bore interlocking arrangement that includes a pin projecting outwardly from the ball of the boom that is received in a bore formed in the cradle when the ball is seated in the socket.

A fastener can be employed that extends through the cradle into the ball to releasably secure the boom to the mounting bracket. In a preferred embodiment, the fastener is a bolt that extends through the bore formed in the cradle into the pin projecting from the ball to secure the boom to the mounting bracket. To enable the position of the boom to be adjusted relative to the door, the fastener can be loosened enabling the boom to be rotated relative to the mounting bracket disengaging the detent arm from one channel with relative rotation continuing until the detent arm is received in another channel.

The mounting bracket and/or straps define a spring that stores potential energy caused by interaction of the animal with the animal plaything and converts the stored potential energy into kinetic energy causing the plaything to rapidly move in a manner that can be random and unpredictable, e.g., leaping and dancing. The boom defines another spring that also stores potential energy resulting from deflection of the boom caused by an animal interacting with the plaything including when the animal interacts with the plaything in a manner that pulls the upper and lower lines taut. When deflection of the boom reaches a certain magnitude or when the animal releases the plaything, the stored potential energy of the boom is converted into kinetic energy that is transmitted through the lines and mobile arm to the plaything causing the plaything to rapidly move relative to the animal in a manner that can be random and unpredictable.

The upper line defines a further spring that can function both as a tensile spring and torsion spring. The lower line defines a still further spring that also can function both as a tensile spring and torsion spring. The upper and lower lines can function as a tensile spring when one or both are pulled taut by an animal batting or pulling on the plaything. The upper and lower lines also can function as a torsion spring when one or both are twisted including when an animal bats or pulls on the plaything during interaction with the plaything.

In a preferred embodiment, at least the upper line functions at least as a torsion spring. In a preferred embodiment, both the upper line and lower line function as both a tensile spring and torsion spring. In a preferred embodiment, at least the upper line and preferably both lines are constructed of a woven or braided filament that can be coated, such as with a plastic coating, that facilitates storage of potential rotational energy. A preferred upper and/or lower line is formed of fishing leader line constructed of braided steel cable coated with a plastic, e.g., nylon, coating.

The mobile includes a mobile arm that is elongate having the upper and lower lines attached on opposite sides of a midline of the arm. One of the lines can be adjustably attached to the mobile arm in a manner permitting its position relative to the midline of the arm to be changed. In one preferred embodiment, one of the lines is adjustably attached to the mobile arm by a slidable collar that is slidable along the mobile arm to change the distance of the line from the midline such as to change the orientation, e.g., at rest orientation, of the arm. In one preferred embodiment, adjustable attachment permits balancing of the mobile in a manner that helps maintain the mobile arm in a desired orientation, such as in a generally horizontal orientation, and that helps return the arm to the generally horizontal orientation when at rest.

The mobile can include a drive carried by the boom that rotates the mobile to entice interaction of the animal with the plaything. In a preferred embodiment, the mobile includes a drive that is mounted to the free end of the boom and includes a prime mover that preferably is an electric motor. The motor has a rotary output shaft coupled to an armature attached to the upper line offset a distance from the motor rotational axis causing the upper line to orbit about the motor rotational axis causing the mobile arm, lower line, and animal plaything to spin or rotate.

In a preferred method of operation, the electric motor is operated for a first period of time and then paused for a second period of time with operation of the motor controlled to alternate between periods of operation and periods where the motor is paused. In a preferred implementation of the method, the motor is operated during the first period of time rotating the mobile in one direction causing the upper line to function as a torsion spring to store potential rotational energy and then paused during the second period of time causing potential rotational energy stored in the upper line to be converted to kinetic rotational energy rotating the mobile in an opposite direction. In a preferred implementation of the method, the motor is operated during the first period of time orbiting the upper line about the motor rotational axis rotating the mobile in one direction and then immediately paused during the second period of time allowing the potential energy stored in the upper line to be converted into rotational energy causing the mobile to rotate in an opposite direction about the upper line.

Other advantages, benefits and features of the present invention will become apparent to those skilled in the art upon reading the detailed description and viewing the related drawings.

### DRAWING DESCRIPTION

At least one exemplary embodiment of the invention is illustrated in the accompanying drawings in which like reference numerals represent like parts throughout and in which:

FIG. 1 is a perspective view of an animal mobile constructed in accordance with the present invention removably mounted to a door and being interacted with by a cat;

FIG. 2 is a perspective view of a mounting bracket used to releasably mount the mobile to a door;

FIG. 3 is a cross sectional view of the mounting bracket taken through an endwall of the bracket that abuts an outer edge of a door extending through a portion of a boom and bracket coupling arrangement;

FIG. 4 is an exploded perspective view of the boom and bracket coupling arrangement;

FIG. 5 is a fragmentary top plan view of the boom and bracket with a portion of a ball and socket boom and bracket coupling arrangement broken away to show more detail and depicting a plurality of boom mounting positions;

FIG. 6 is a fragmentary perspective view of a portion of the mobile depicting in more detail an upper line from which a mobile arm is suspended from the boom, the mobile arm including an adjustable line position mounting arrangement, and a lower line from which an animal plaything is suspended;

FIG. 7 is an enlarged fragmentary cross-sectional view of at least one of the upper and lower lines showing details of line construction;

FIG. 8 is a bottom perspective view of a drive head of the mobile with a battery cover removed illustrating its battery compartment and showing a rotary armature to which the upper line of the mobile is connected;

FIG. 9 is a cross sectional view of the drive head of FIG. 8;

FIG. 10 is a schematic depiction of rotation of the mobile in one direction during mobile drive motor operation; and

FIG. 11 is a schematic depiction of rotation of the mobile in an opposite direction caused by conversion of stored mobile potential energy into rotational kinetic energy when the motor is paused.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

FIG. 1 illustrates an animal entertainment device 20 that is an animal mobile 22 constructed in accordance with the present invention that is removably mounted to a door 24 by a mount 26 from which an animal plaything carrying boom 28 is outwardly cantilevered. The elongate boom 28 carries a mobile head 30 from which a first elongate line 32 downwardly extends to a generally horizontally extending mobile arm 34 that carries an animal plaything 36. In the preferred embodiment shown in FIG. 1, animal plaything 36 is an animal toy 38 suspended from the mobile arm 34 by another elongate line 40 a distance from mobile arm suspension line 32. In use, the mobile 22 defines a spring-mass system that is configured to provide an opposition force to an animal 42 engaging the toy 38 in a manner that causes it to rapidly move away from the animal 42 when it disengages or the animal 42 releases the toy 38. As discussed in more detail below, the mobile head 30 can be configured with a drive 44 that is operable to induce movement of the arm 34 through movement of the mobile arm suspension line 32 that in turn induces movement of the animal plaything 36 through movement of the plaything suspension line 40. Such movement is in a plurality of directions and/or rotations in a manner that causes the animal plaything 36 to move an enticing manner that encourages the animal 42 to interact, e.g., play, with the animal plaything 36.

As is shown in FIG. 1, animal mobile 22 is configured to extend outwardly from a stile or end 46 of a door 24 having a boom length, upper and lower suspension line lengths, and a mobile arm configuration that positions the animal plaything 36 within reach of an animal 42, preferably a cat 48, sitting on the floor 50 adjacent the door 24. For example, as is shown in FIG. 1, such an animal mobile 22 constructed in accordance with the present invention is configured to enable a cat 48 sitting on the floor 50 reaching up with one of its paws 52 to be able to bat the animal plaything 36 with the paw 52 as well as to stand on its back legs 54 and/or haunches to be able to capture the animal plaything 36 with both paws 52.

The animal mobile 22 is configured to provide a spring mass system 56 that includes the boom 28, the upper mobile arm suspension line 32, mobile arm 34, as well as the lower plaything suspension line 40 that permits a cat 48 to grasp and pull animal plaything 36 downwardly and/or away from the door 24 until the lines 32 and 40 become substantially taut providing a force in tension that opposes the cat 48. During cat interaction, the animal plaything 36 is a first mass is attached by plaything suspension line 40 to mobile arm 34, a second mass, in a manner that permits the line 40 and plaything 36 to swing and pivot back and forth about a point of attachment 58, i.e., pivotable attachment, of the line 40 to the arm 34. The mobile arm 34 is attached to mobile arm suspension line 40 at a point of attachment 60 spaced from plaything suspension line attachment point 58 that permits the arm 34 to pivot about the mobile arm suspension line attachment point 60.

For example, the attachment point 60 of the mobile arm suspension line 40 is spaced from the attachment point 58 of the plaything suspension line 40 enabling a force applied by the plaything suspension line 40, such as by a cat 48 batting or pulling on the plaything 36, to cause the mobile arm 34 to pivot about attachment point 60 in at least one of an up or down direction 62 and a side to side or rotational direction 64 as depicted in FIG. 1, providing a plurality of degrees of freedom. In addition, at least one additional degree of freedom is provided when the lines 32 and 40 are pulled taut by the cat 48 as the boom 28 and/or the mount 26 provide(s) some give, allowing the head 30 to move at least somewhat relative to the door 24 and floor 50. For example, a cat 48 can pull the plaything 36 downwardly toward the floor 50 until the lines 32 and 40 are taut bending the boom 28 and/or deflecting the mount 26 in a direction generally opposite the force applied by the cat 48, such as the generally vertical direction 66 illustrated in FIG. 1 in response to a generally downwardly pulling force exerted by the cat 48 on the plaything 36.

FIGS. 2-5 illustrate a preferred embodiment of a mount 26 used to releasably attach the mobile 22 in an operating position where the mobile 22 can be interacted with by a cat 48. The mount 26 includes a generally U-shaped mounting bracket 68 having an outer boom supporting wall 70 from which the boom 28 is outwardly cantilevered and a pair of spaced apart, generally parallel, and generally transverse door straddling flanges 72 and 74 extending outwardly from wall 70 defining a door-receiving channel. Bracket 68, including wall 70 and flanges 72 and 74, preferably is of one-piece, unitary and substantially homogenous construction, such as by being molded out of plastic as a single piece. With additional reference to FIG. 1, the mount 26 further includes an elongate strap 76 extending outwardly from a corresponding flange 72 and 74 that wraps around a respective door knob or handle 78 extending out from opposite sides 80 and 82 of the stile 46 of the opened door 24.

The boom supporting wall 70 of the mounting bracket 68 defines a door stile abutment 84 that abuts the outer edge or stile 46 of the door 24 (shown in phantom in FIG. 2) when the mobile 22 is mounted to a door. The abutment 84 is formed by a generally planar or generally flat inner surface 86 of the wall 70 that faces toward the stile 46 when mounted to the door 24 that can have a resilient pad 88, such as a resilient compressible foam pad, adhesively attached to the abutment 84. The flanges 72 and 74 are opposed to one another and spaced apart to straddle the door 24 with each flange 72 and 74 having an inner door facing surface 90 that can also have a resilient pad 92, e.g., foam pad, adhesively attached to it.

Each pad 88 and 92 helps protect the door 24 from the bracket 68 during use and operation of the mobile 22 and can also help frictionally engage a portion of the door 24 with which the pad 88 and 92 contacts when the mobile 22 is mounted to the door 24. Where pads 88 and 92 are used, the pads 88 and 92 help more firmly and more securely mount the mobile 22 to the door 24. Depending upon the space between the flanges 72 and 74, pads 88 and 92 can frictionally engage a corresponding portion of the door 24 in a manner that can help clamp the bracket 68 to the door 24 and/or result in a friction fit with the door 24 provided by the pads 92 attached to the opposing flanges 72 and 74. In a preferred embodiment, at least pads 92 provide a friction fit with the door 24 when the U-shaped bracket 68 is attached to the door 24 with the pad 88 of the abutment 84 against the outer edge or stile 46 of the door 24 and each pad 92 engaging a corresponding outer side of the stile 46 of the door 24.

As is best shown in FIG. 2, the boom supporting wall 70 of the bracket 68 is generally rectangular having a pair of sides 94 and 96 from which a respective flange 72 and 74 outwardly extends, a bottom edge 98 and a top edge 100 with a bolt clearance recess 102 allowing attachment of the bracket 68 adjacent the door knobs 78 of a door 24 underneath an outwardly extending bolt 104 of the door 24, e.g., latch bolt 104. While bolt clearance recess 102 is shown in FIG. 2 as being an arcuate or curved portion of the top edge 100, the recess 102 can also be generally U-shaped, if desired, such as depicted in FIG. 1. In at least one preferred mounting arrangement, the bracket 68 is attached to the door 24 with at least part of the top edge 100 of bracket wall 70 extending along the clearance recess 102 abutting against at least part of the outwardly extending latch bolt 104 of the door 24. Such a clearance recess 102 not only helps locate the mounting bracket 68 during mounting on the door 24, the top edge 100 of the bracket wall 70 bearing against the latch bolt 104 of the door 24 when mounted helps to more securely and stably attach the bracket 68 to the door 24.

The boom supporting wall 70 of the mounting bracket 68 includes an outwardly extending boom cradle 106 to which the boom 28 is attached. As is shown in FIGS. 2-5, the boom 28 is an elongate tube 108, such as a plastic tube, having an end cap 110 that includes a tubular sleeve 112 that couples with the boom tube 108 and a ball 114 received in a socket 116 formed in the cradle 106 defining a ball and socket boom coupling arrangement. Tube 108 and sleeve 112 are configured to provide slidable telescopic engagement therebetween defining a connection that can be of snap-fit construction. In the embodiment shown in FIGS. 2-5, the tube 108 is slidably telescopically received in the sleeve 112 of the end cap 110 but can be oppositely assembled with the sleeve inserted into the tube if desired. As is best shown in FIG. 4, the tube 108 has a tab 118, such as a circular projecting boss, which snaps into a receptacle 120, such as a bore, formed in the sleeve 112. Where the sleeve inserts into the tube, the receptacle can be formed in the tube and the tab formed in the sleeve.

A preferred embodiment of the boom coupling arrangement used to mount the boom 28 to the mounting bracket 68 is shown in FIGS. 2-5 and can be configured as depicted in FIGS. 4 and 5 to enable the boom 28 to be adjustably mounted to the bracket 68. In a preferred embodiment, the boom 28 is mounted to the bracket 68 in a manner that enables position of the boom 28 to be adjusted relative to the bracket 68 and to the door 24, such as by enabling the boom 28 to be swiveled and locked in place. In the preferred coupling arrangement shown in FIGS. 4 and 5, the boom 28 can be releasably locked in place to the bracket 68 in a plurality of positions such as depicted in FIG. 5.

With specific reference to FIG. 4, the socket 116 of the cradle 106 is formed by a land 122 bounded by an upraised lip 124 of a support 126 that cantilevers outwardly from the bracket wall 70 that includes a pair of spaced apart and downwardly extending stiffening and strengthening ribs 128 underlying the support 126. The support 126 and land 122 define a ledge upon which the ball 114 rests when the boom 28 is mounted to the bracket 68. The ball 114 has a flat 130 that overlies the land 122 of the socket 116 when the boom 28 is mounted to the bracket 68 by a fastener 132, such as the threaded bolt 132 shown in FIG. 4, which extends through the support 126 into the ball 114 attaching the ball 114 to the support 126. Land 122 and flat 130 define a pair of engagement surfaces in contact with one another when the ball 114 is received in the socket 116 and attached by the fastener 132 to the bracket 68. Fastener 132 can also extend through a washer 134, such as depicted in FIG. 4, which opposes disengagement of the fastener 132. Flat 130 can include an extension 168 that bears on the lip 124 when the boom 28 deflects during mobile operation to help spread area over which the force acting on the boom is transferred to the bracket 68.

The boom coupling arrangement can include a pin and bore interlocking arrangement that not only facilitates positioning or adjustment of the boom 28, but which also more evenly distributes forces transmitted by a cat 48 playing with the animal plaything 36 through line 40, arm 34, line 32, boom 28 and to the bracket 68. A preferred pin and bore interlocking arrangement shown in FIGS. 4 and 5 includes an annular pin 136 projecting outwardly from the flat 130 of the ball 114 that is received in a bore 138 formed in the land 122 of the socket 116. The pin 136 has an annular outer surface 140 that engages a generally complementary annular surface 142 defining the pin-receiving bore 138 when the ball 114 is received in the socket 116. Pin 136 has an end wall 144 with a bore 146 formed in it that receives the threaded end of fastener 132 when the ball 114 is received in the socket 116 and attached to the mounting bracket 68. In the preferred embodiment shown in FIGS. 3 and 4, the bore 146 is internally threaded to threadably receive and engage the threaded end of fastener 132. If desired, the pin can be formed in the cradle 106 and bore formed in the ball 114.

Annular surfaces 140 and 142 define a second pair of engagement surfaces contacting one another when the boom end cap 110 is attached to the mounting bracket 68. Annular surfaces 140 and 142 locate the ball 114 in the socket 116 during assembly as well as allow the ball 114 to be pivoted relative to the socket 116 in adjusting the position of the boom 28. Annular surfaces 140 and 142 provide engagement surfaces that are generally transverse to the land 122 and flat 130 and to the tube 108 of the boom 28 when the boom 28 is attached to the bracket 68 in the manner depicted in FIGS. 2 and 3. Providing such a pair of engagement surfaces 140 and 142 generally transverse to the longitudinal extent or axis of the boom tube 108 and to the first pair of engagement surfaces 122 and 130 of the ball 114 and socket 116 helps more uniformly spread out and transfer boom forces and bending moments to the bracket 68 during mobile operation.

The boom coupling arrangement preferably includes a boom position adjustment arrangement configured to enable the angle of the boom 28 to be adjusted. With reference to FIGS. 4 and 5, the outer surface 148 of the ball 114 has a plurality of pairs, i.e., at least three, of circumferentially spaced generally axially extending channels 150, 152 and 154 that receive a tab 158 of a detent finger 156 formed in the boom supporting wall 70 that is resiliently biased toward the socket 116. As is best shown in FIG. 5, the tab 158 of the finger 156 is receivable in one of the channels 150, 152 or 154 locking the boom 28 in one of three angular boom positions 160, 162 or 164 where a first one of the positions 162 orients the boom 28 outwardly in line and generally parallel to the door 24, a second one of the positions 160 orients the boom 28 outwardly at an oblique angle, e.g., toward the left or top, relative to the door 24, such as shown in phantom in FIG. 5, and a third one of the positions 164 orients the boom 28 outwardly at an opposite oblique angle, e.g., toward the right or bottom, relative to the door 24, such as also shown in phantom in FIG. 5.

Such engagement between the tab 158 of the finger 156 received in one of the plurality of channels 150, 152 or 154 and the corresponding recessed channel defining recessed surface 166 formed in the outer surface 148 of the ball 114 locks the boom 28 in the corresponding angular position relative to the door 24 when the ball 114 is seated in the socket 116 and the fastener 132 attached. In the preferred embodiment shown in FIGS. 3-5, the finger 156 resiliently outwardly biases the tab 158 into one of the respective channels 150, 152 or 154 in the ball 114 in a manner that seats the ball 114 in the socket 116 helping to provide a positive and secure coupling therebetween. This boom position adjustment arrangement retains the boom 28 in one of a plurality of positions, e.g., one of three positions, with the finger 156 biasing the tab 158 into a corresponding channel 150, 152 or 154 in a manner that can provide a snap fit between the tab 158 and ball 114. Such an outwardly biased finger construction also causes the tab 158 to apply an outward biasing force against the ball 114 that also helps facilitate engagement between the pin 136 projecting from the bottom of the ball 114 and the surface 142 defining the pin-receiving bore 138 formed in the socket 116.

Such an outwardly biased finger construction advantageously also permits the angular position of the boom 28 to be adjusted from one of the plurality of boom positions 160-164 to another one of the plurality of boom positions 160-164 without completely decoupling the ball 114 from the socket 116. In one method of adjusting boom position, the fastener 132 is loosened and a force is applied to the boom 28 in a direction generally transverse to its longitudinal extent. When enough force is applied, the tab 158 of the finger 156 is urged outwardly toward the door 24 until the tab 158 clears the boom position locking channel, e.g., channel 150, 152 or 154, in which it was previously seated. Once the tab 158 clears the channel, the boom 28 and ball 114 are rotated in unison about a rotational axis provided by the pin 136 received in the bore 138 in the socket 116 until the tab 158 seats in an adjacent channel, e.g., one of the other channels 150, 152 or 154, locking the boom 28 in the new angular position. After that, fastener 132 is tightened to secure the ball 114 to the socket 116 immovably locking the position of the boom 28 in the new position.

When the ball 114 is secured in the socket 116 and attached to the cradle 106 by the fastener 132, the flat 130 formed in the bottom of the ball 114 overlies and slidably engages the land 122 formed in the socket 116 in a manner that provides some give and imparting some springiness to the coupling arrangement attaching the boom 28 to the mounting bracket 68. Engagement between the pin 136 and the inner surface 142 formed in the socket 116 or cradle 106 that defines the pin-receiving bore 138 also provides some give and imparts some springiness to the coupling arrangement attaching the boom 28 to the bracket 68.

To better handle the wide variety of loads that the boom coupling arrangement can encounter during use and operation of the mobile 22, the ball 114 can have a section 168 of the flat 130 that extends longitudinally toward the boom tube 108 that can abut against the curved lip 124 bounding the generally circular land 122 when enough downward force is applied to the boom 28. As is best shown in FIG. 4, the lip 124 defines at least a semi circle extending toward the bracket wall 70 until the lip 124 converges with a corresponding one of the ball engaging abutments 170 and 172 disposed on either side of finger 156. Each ball engaging abutment 170 and 172 has a curvilinear contact surface 174 that increases the surface area of contact between the bracket 68 and the ball 114 by engaging a respective portion of the hemispherical outer surface 148 of the ball 114 when attached to the bracket 68 by a fastener 132. Such increased surface area of contact between the ball 114 and the socket 116 or cradle 106 advantageously increases the magnitude of forces and bending moments that can be transmitted from the boom 28 during mobile operation to the mounting bracket 68 and to the door 24. The ball engaging abutments 170 and 172 also help locate or seat the ball 114 in the cradle 106 or socket 116 during assembly of the boom 28 to the bracket 68.

As previously discussed, the mount 26 provides a door mounting arrangement that includes the generally U-shaped mounting bracket 68 having a pair of flanges 72 and 74 that straddle opposite sides 80 and 82 of a door 24 to which the mobile 22 is removably mounted. The door mounting arrangement also includes a pair of flexible straps 76 attached to a respective bracket flange 72 and 74 that wraparound a respective one of the door knobs 78 of the door 24 during mounting of the bracket 68 to the door 24. As is shown in FIGS. 2-4, each strap 76 extends through a slot 176 formed in a respective one of the bracket flanges 72 and 74, is overlapped with part of the strap 76, and joined together, such as by stitching, forming an attachment loop 178 attaching the strap 76 to flange 72 and 74.

With specific reference to FIG. 4, each strap 76 is an elongate flexible ribbon 180 of a hook and loop material, e.g., VELCRO, having one surface 182 of hook material 184 having a plurality of pairs, i.e., at least three, of hooks extending substantially the length of the strap 76 and having an opposite surface 186 of loop material 188, or a pile, having a plurality of pairs of hook engaging loops extending substantially the length of the strap 76. Such a ribbon 180 can have flat and generally parallel opposite surfaces 182 and 186 as depicted in FIGS. 2-4. Such a strap construction is advantageous as it enables each strap 76 to be packaged in a roll 190 while attached to the bracket 68 as shown in FIG. 2 with the hook material 184 on one side of each strap 76 engaging the loop material 188 on the other side of the strap keeping each strap rolled up in a roll 190 during packaging and shipping. In addition, providing each strap 76 rolled up in a roll 190 like that depicted in FIG. 2 advantageously provides a strap 76 in an easy to unroll arrangement that facilitates simple and easy unfurling of the roll 190 during mounting of the bracket 68 to the door 24.

In a method of mounting the bracket 68 to the door 24, the bracket 68 is positioned so that its outer boom supporting wall 70 abuts against the edge or stile 46 of the door 24 with one of the bracket flanges 72 straddling one side 80 of the door 24 and the other one of the bracket flanges 74 straddling the other side 82 of the door 24. With specific reference to FIGS. 1-3, the top edge 100 of bracket wall 70 underlies the latch bolt 104 of the door knob assembly of the door 24 having latch bolt clearance or locator recess 102 that can be disposed in registry with or abutting the bottom of part of the bolt 104. As is depicted in FIG. 3, each strap roll 190 is manually unfurled and wrapped around a stem 192 of a corresponding one of the door knobs 78 that extends outwardly from the door 24 between the door 24 and the knob 78. With continued reference to FIG. 3, the strap 76 is unfurled and wrapped around the door knob stem 192 keeping the hook material side 182 always facing the loop material side 186 while being wrapped around the door knob stem 192 so that a plurality of layers 194 and 196 of the strap 76 are wrapped around at least a portion of the stem 192 and engage one another securing the strap 74 to the stem 192. In a preferred implementation of such a door mounting method, each strap 76 is wrapped around the stem 192 a plurality of times. As is shown in FIG. 3, the slot 176 locates the strap 76 at a level substantially the same as or higher than that of the support ledge 126 to produce a moment that offsets the moment created by the boom 28 attached to the bracket 68. Straps 76 wrap around the door handle stem 192 with the stem 192 at substantially the same height or higher than the support ledge 126 for the same reason with the bottom half of the door abutment 48 acting as a force transferring lever that transfers at least part of the force of a downwardly bending moment about the location where the straps 76 attach to the bracket 68 created by the weight of the plaything 36, line 40, arm 34, line 32 and boom 28 to the stile 46 of the door 24 and forces exerted on the mobile 22 by a cat 48 during use and operation. Straps 76 not only oppose the bending moment created about the bottom half of the abutment 48, by holding the bracket 68 against the door 24, the straps 76 transfer at least some of the force due to the weight of the mobile 22 as well as due to cat interaction, but also create a moment opposing the moment tending to want to pull the bracket 68 free of the door 24 helping to hold the bracket 68 stably in place on the door 24. Although the door 24 shown in FIG. 1 is equipped with knobs 78 that are rotatable, the door mounting strap arrangement is also well suited for use where rotatable or otherwise displaceable door levers are used in place of knobs. Such a door mounting arrangement can also be used with door handles that are fixed, i.e., not rotatable.

Such a door mounting arrangement utilizing hook and loop fastener ribbon attachment straps 76 to removably yet securely attach the mounting bracket 68 of the mobile 22 to a door 24 results in a mounting arrangement of resilient and strong construction that together with the bracket 68 functions as a spring that alternately stores and releases energy transmitted to it during operation of the mobile 22. For example, a cat 48 batting or pulling on the animal plaything 36 will cause forces to be transmitted through line 40, arm 34, line 32 and boom 28 to the bracket 68 and attachment straps 76 causing the bracket 68 and straps 76 to rapidly store and release energy. Storage of this energy typically results in deflection of the straps 76 such as by causing one or both straps 76 to stretch a relatively small amount. Storage of this energy can also cause deflection in the coupling between the boom 28 and mounting bracket 68. Such storage and releasing of energy advantageously further helps to entice the cat 48 to continue interacting with animal plaything 36 by causing the released energy to be translated into relatively rapid and jerky movement or “spring back” of the mass-possessing animal plaything 36 causing it to “leap” and/or “dance” in a realistic or alive manner.

The elongate boom 28 acts as a second spring that also alternately stores and releases energy during mobile operation. The boom 28 stores potential energy resulting from the boom deflecting in response to forces of the cat 48 batting or pulling on the animal plaything 36 when interacting with the mobile 22. For example, as the cat 48 grasps and pulls the animal plaything 36, the force of the cat 48 pulling on the plaything 36 is transmitted through line 40, arm 34, and line 32 to the boom 28 causing at least some deflection of the boom 28 in response. When the cat 48 releases the plaything 36, potential energy corresponding to the amount of deflection of the boom 28 is released creating a force acting in an opposite direction that is transmitted via line 32, arm 34 and line 40 to the plaything 36 causing the plaything 36 to rapidly accelerate and move. Because line 32 is flexible and pivotally mounted to both the boom 28 and arm 34 and because line 40 is pivotally mounted to both the arm 34 and plaything 36, the conversion of such potential energy into kinetic energy causes the plaything 36 to move rapidly and unpredictably in at least some instances making the plaything 36 appear to “dance” or “leap” as if it were alive.

With reference to FIGS. 1, 6 and 7, the mobile 22 has an elongate upper line 32 that hangs downwardly from at or adjacent the free end of the boom 28 that is cantilevered outwardly from the mounting bracket 68. The elongate line 32 hangs downwardly forming a first pendulum extending from the boom 28 to the mobile arm 34 about which the entire mobile 22 can swing back and forth as well as in a circle, e.g., in a cone-shaped pattern. For example, when the plaything 36 is batted or captured and released, the corresponding forces transmitted by the cat 36 to line 40, arm 34, to line 32, to the boom 28, etc. cause the plaything 36 and arm 34 to swing on the upper line 32 in such a pendulum like fashion helping to further entice the cat 48 into continued interaction with the mobile 22. As a result of the upper line 32 being able to move in such a pendulum like fashion, line 32 attaching the mobile arm 34 to the boom 28 provides a first degree of movement to the mobile 22.

The mobile 22 also has an elongate lower line 40 that hangs downwardly from the mobile arm 34 and carries the animal plaything 36. As with the elongate upper line 32, the lower line 40 is pivotally attached to the mobile arm 34 defining a second pendulum allowing the line 40 and plaything 36 to swing back and forth as well as in a circle, e.g., in a cone-shaped pattern during interaction by the cat 48 with the mobile 22. For example, when the plaything 36 is batted or captured in released, the corresponding forces transmitted by the cat 36 to line 40, arm 34, to line 32, to the boom 28, etc. cause the plaything 36 to swing on the lower line 40 in such a pendulum like fashion helping to further entice the cat 48 into continued interaction with the mobile 22. As a result of the lower line 40 being able to move in such a pendulum like fashion, line 40 attaching the animal plaything 36 to the to the mobile arm 34 provides a second degree of movement to the mobile 22.

As is best shown in FIG. 6, the mobile arm 34 is elongate and can be tubular such as by being formed of an elongate tube 198, e.g., plastic tube, capped by a pair of end caps 200 and 202 one of which has a mass greater than the other end cap providing a counterbalance or counterweight 204. As is shown in FIG. 6, counterweight 204 is disposed outwardly of lines 32 and 40 with upper line 32 located between the lower line 40 and counterweight 204. To help generally horizontally balance the arm 34 when the mobile 22 is substantially static, as well as to help return the arm 34 to a generally horizontal orientation during mobile operation, the upper line 32 is mounted by a position-adjustable collar 206 to the mobile arm tube 198 between the counterweight 204 and a midpoint of the arm 34 represented by intersecting midline 208 in FIG. 6. The position-adjustable collar 206 includes a thumbscrew 210 that can be loosened to enable the collar 206 to be slid along the tube 198 between the end caps 200 and 202, including to balance the mobile 22 so the arm 34 seeks a generally horizontal orientation when the mobile 22 is at rest. When the collar 206 has been slid on the tube 198 to the desired position, preferably a position that is between midline 208 and the counterbalance or counterweight 204, the thumb screw 210 is tightened until it locks the collar 206 in place on the tube 198.

The lower line 40 is attached at one end to the tube 198 of the mobile arm 34 on a side of the tube 198 opposite the side of the tube 198 the upper line 32 is attached. For example, as is shown in FIG. 6, the lower line 40 is attached to the tube 198 at a point of attachment 58 that is located at or adjacent an end of the tube 198 opposite that of the counterweight 204 with the point of attachment 58 of the lower line 40 being on one side of midline 208 and the point of attachment 60 of the upper line 32 being on the other side of midline 208. Such a construction provides a third degree of freedom to the mobile 22 by allowing the mobile arm 34 to function as a rocker arm that is pivotable about the point of attachment 60 of the upper line 32 to the arm 34 with the point of attachment 60 being a fulcrum.

During interaction by a cat 48 with the animal plaything 36, batting or grasping the plaything 36 causes the arm 34 to pivot or rock about the point of attachment 60 of the upper line 32 to the arm 34. After batting of the plaything 36 has occurred and/or when the cat 48 has released the plaything 36, the counterweight 204 causes the mobile arm 34 to pivot back toward generally horizontal in a direction opposite the batting or grasping force caused the arm 34 to initially pivot or rock. Such pivoting action during cat interaction causes the arm 34 to pivot or rock about the upper line point of attachment 60 in either a vertical direction and/or a generally horizontal direction with the direction of pivoting and/or rocking being at least somewhat determined by the direction of force of the cat 48 interacting with the animal plaything 36 and can also be determined in part by substantially simultaneous release of potential energy by one or more of the springs of the mobile 22.

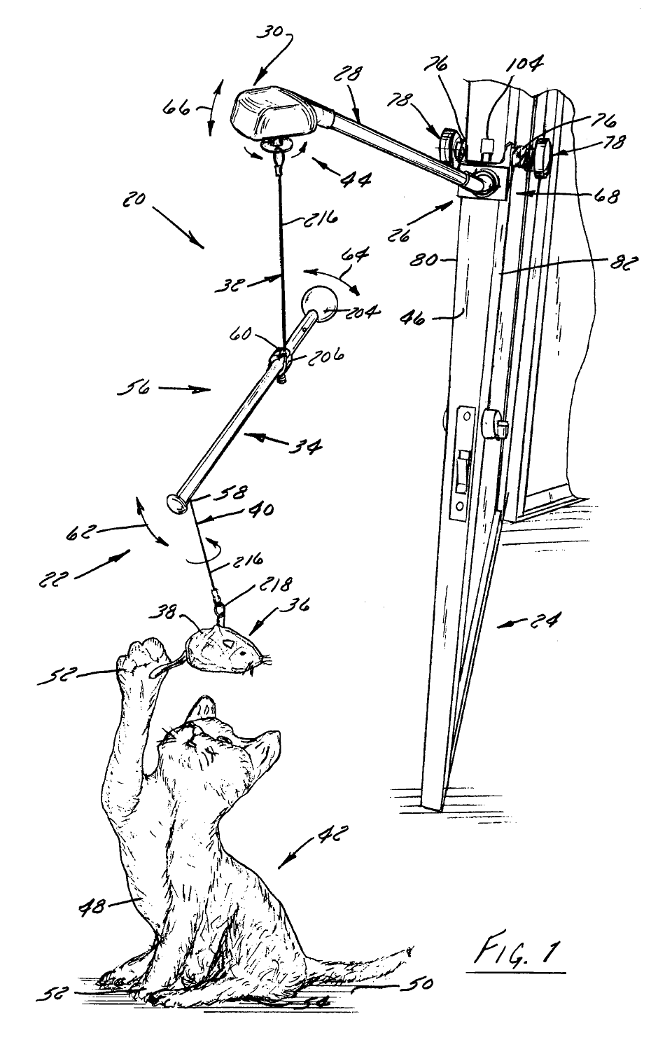

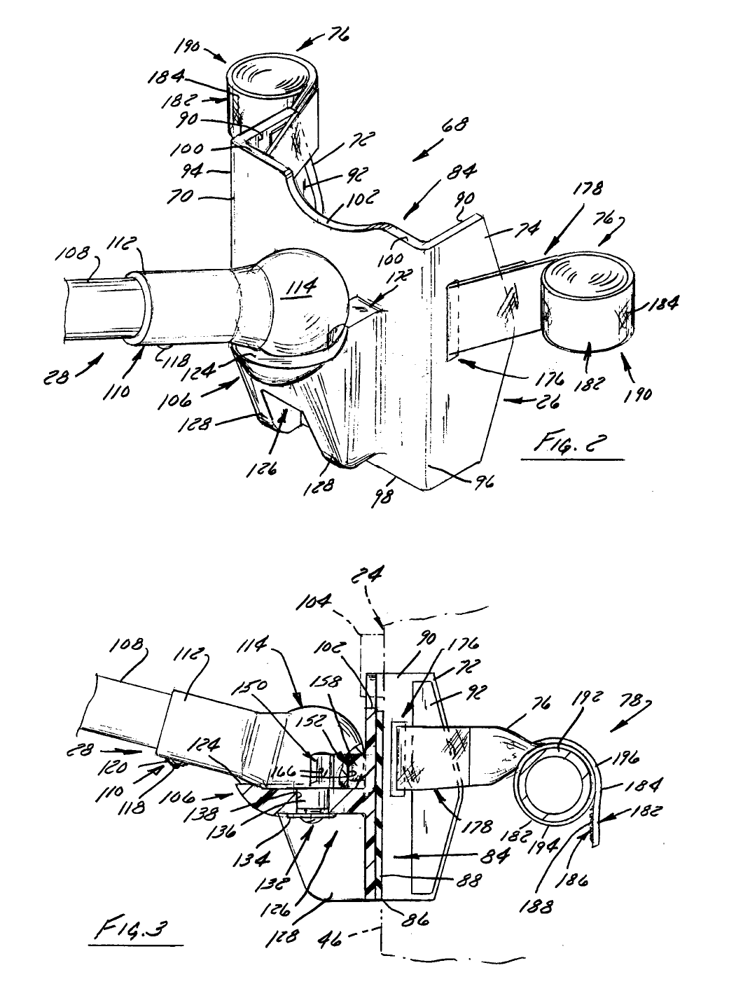

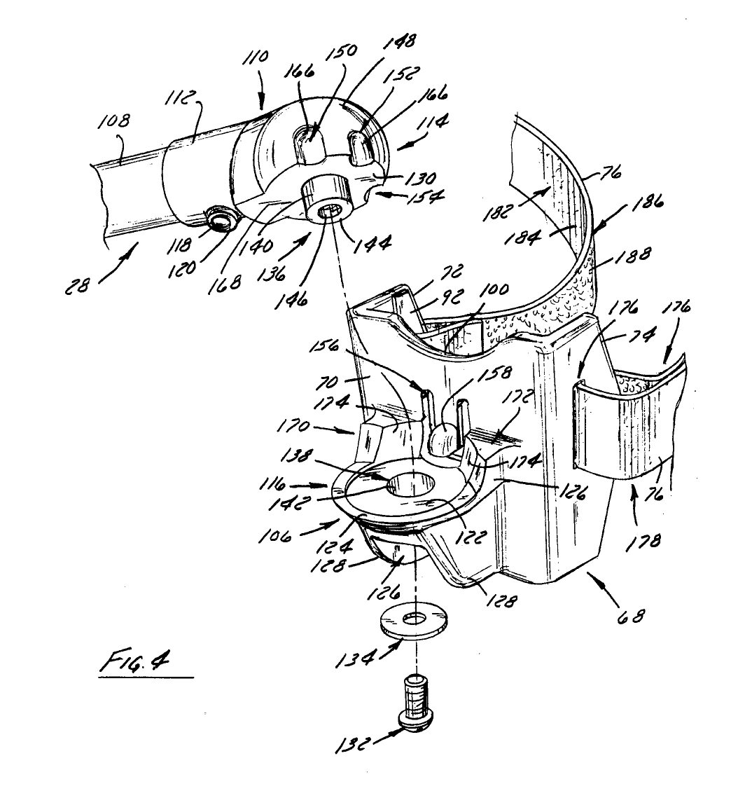

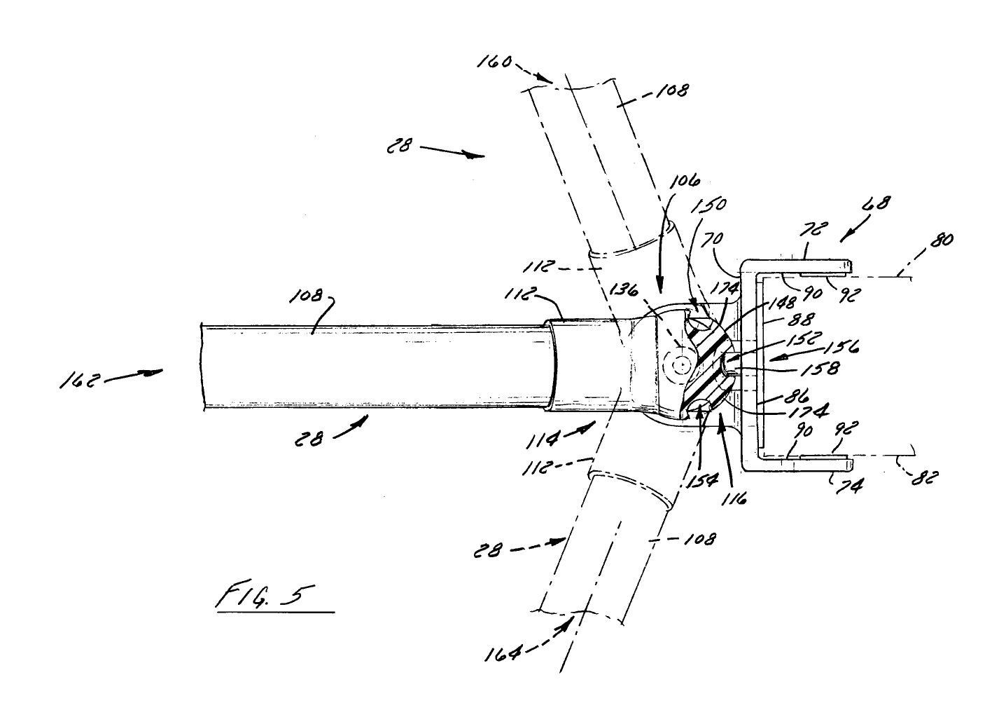

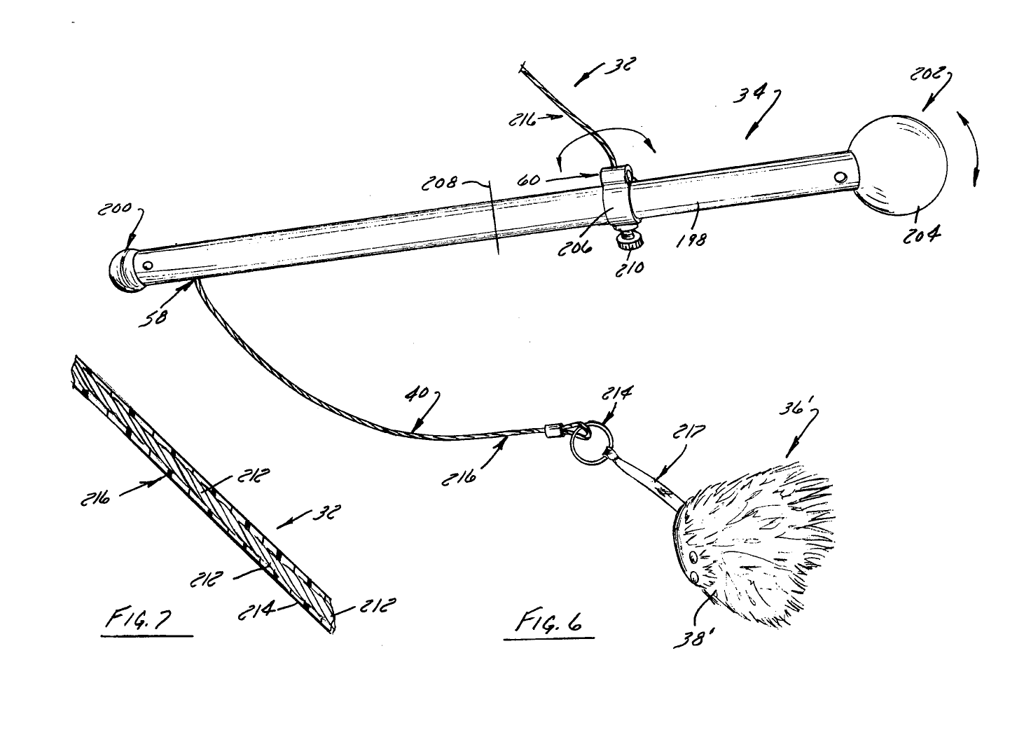

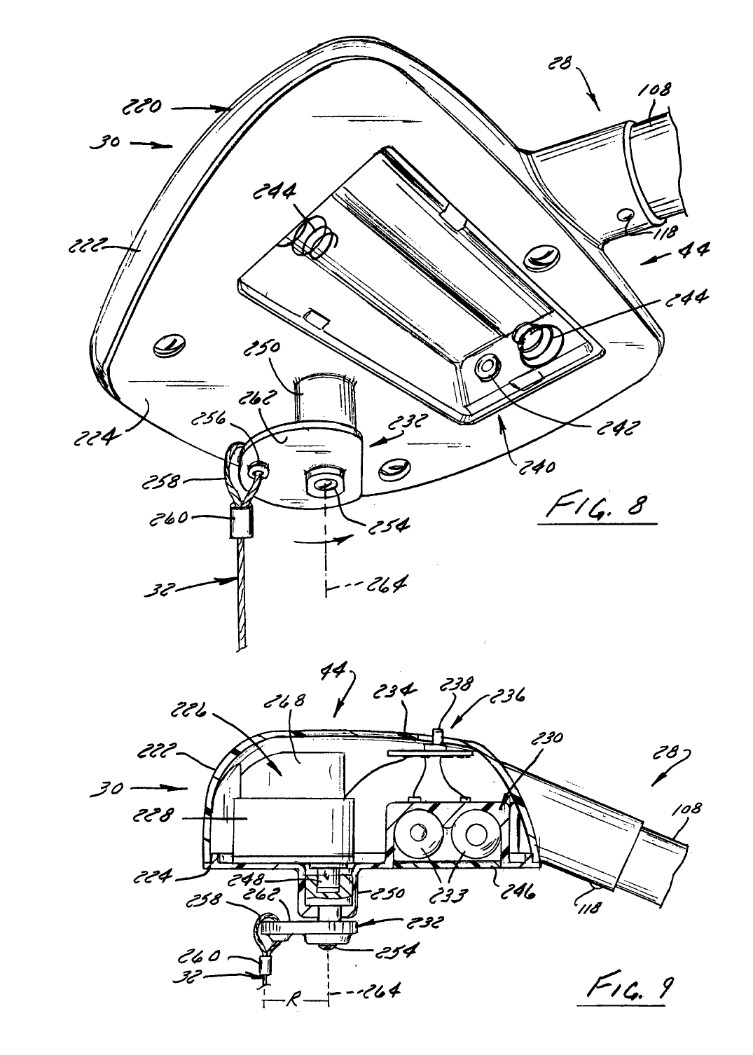

FIG. 6 illustrates the lines 32 and 40 of the mobile 22 in more detail. To avoid a cat 48 from getting entangled in either line 32 and 40, each line 32 and 40 is flexible yet relatively stiff. With reference to FIG. 7, one or both lines 32 and 40 are made of a plurality of braided filaments 212 that are encased or covered in plastic 214, e.g., nylon. One preferred line 32 and/or 40 is constructed of a one millimeter width or diameter fishing leader line 216 made of plastic coated braided steel, e.g., braided stainless steel cable, having steel filaments 212 braided together. Such a line construction advantageously enables at least line 32 to function as a torsion spring that stores rotational energy when the line is twisted that is released as kinetic energy when line rotation in one direction stops.

In a preferred embodiment, such a line construction enables lines 32 and 40 to function as third and fourth springs that include torsion springs that store rotational energy when the line is twisted that is released as kinetic energy when line rotation in one direction stops. For example, when one of the lines 32 and 40 is rotated or twisted about its longitudinal extent or axis in one direction, such as because of batting or grasping of the plaything 36 and/or lower line 40, potential energy is stored in the twisted line until the line stops twisting. Thereafter, the stored potential energy in the line is converted into kinetic rotational energy that causes the line to twist in the opposite direction. Where this occurs to the lower line 40, conversion of the potential energy built up in the lower line spring rotates the plaything 36. Where this occurs to the upper line 32, conversion of the potential energy built up in the upper line spring rotates the mobile arm 34, the lower line 40 about an axis of rotation generally about the upper line 32.

With specific reference to FIGS. 1 and 6, a mobile 22 constructed in accordance with the present invention can be used with a plurality of different animal playthings. For example, the animal plaything 36 shown in FIG. 1 is a mouse 38 attached to a free end of the lower line 40 by a coupling 218 that preferably is a bolt ring or clasp of conventional construction which is configured to enable the plaything 36 to be removed from the line 40 and replaced with a different animal plaything, such as a bird, fish, feather toy, fuzzy toy, or the like. FIG. 6 illustrates another type of animal plaything 36′ that is a fuzzy toy 38′ attached to the free end by a ring 215 by another line 217 that can be of elastomeric construction. If desired, the ring 215 can be of removable construction, e.g., a bolt ring or clasp type coupling; such that it is contemplated that linking line 217 may not be needed. Other arrangements for attaching the animal plaything 36 or 36′ are contemplated as being within the scope of the present invention. Other types of animal playthings 36 that are cat toys are contemplated for attachment to the lower line 40 of the mobile 22. Such cat toys include fish, other types of birds, feather-type cat toys, and the like.

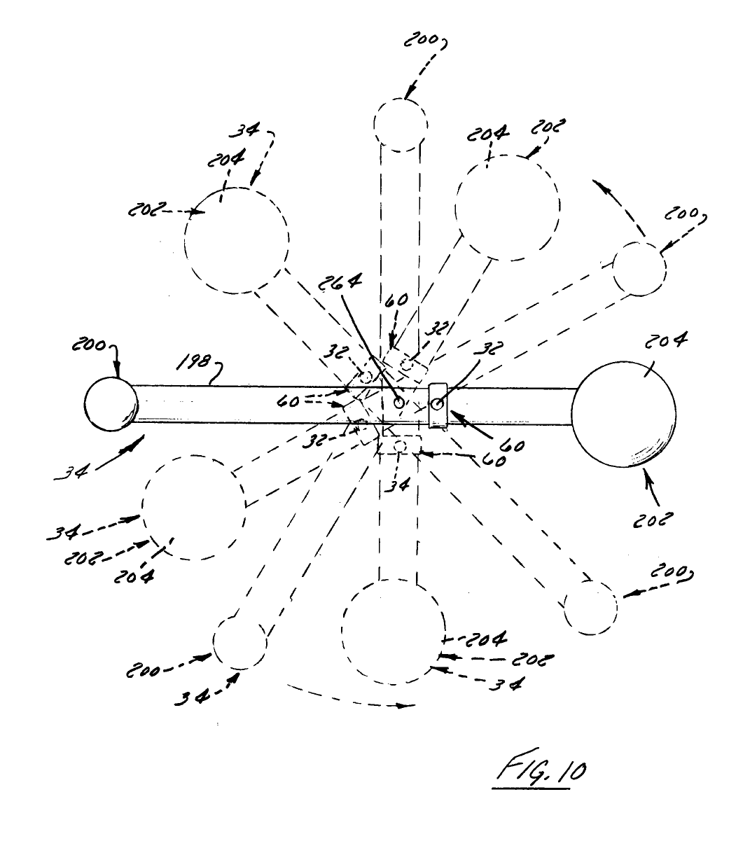

FIGS. 8 and 9 illustrate the mobile drive 44 in more detail. Mobile drive 44 includes a housing 220, e.g., plastic housing, having a top 222 and a bottom 224 that encloses a prime mover 226 (FIG. 9) that preferably is an electric motor 228 powered by a power source 230, such as a plurality of batteries 233, e.g., AA batteries, or the like. As is shown in FIG. 9, the top 234 of the drive housing 220 carries a switch 236 having a switch actuator 238, e.g., slide, handle or button, which is manipulable to turn the mobile 22 on or off. In the preferred embodiment shown in FIGS. 8 and 9, the switch 236 turns the motor 228 on or off. The switch 236 is electrically connected to the batteries 233, which are disposed in a battery compartment 240 having a plurality of battery terminals 242 and 244 covered by a removable cover 246, and electrically connected to the motor 228, such as with wires, as depicted in FIGS. 8 and 9.

The motor 228 has a rotary output shaft 248 disposed in a spacer hub 250 formed in the housing bottom 224 that is attached to an armature 232 by a fastener 254, e.g., screw, such that rotation of the motor output shaft 248 rotates the armature 232 relative to the drive housing 220 substantially in unison therewith. Armature 232 includes an opening 256 through which a loop 258 of the upper line 32 extends that is clamped by a ferrule 260 or the like in manner that prevents detachment of the line 32 from the armature 232. Hub 250 spaces the armature 232 away from the bottom 224 of the housing 220 so that the loop 258 attaching the upper line 32 to the armature 232 does not contact the housing bottom 224 during armature rotation 232. Armature 232 can be generally cardioid-shaped defining a radially outwardly extending arm 262 that offsets the line 32 a distance, R, from an axis of rotation 264 about which the armature 232 rotates when the motor 228 is turned on.

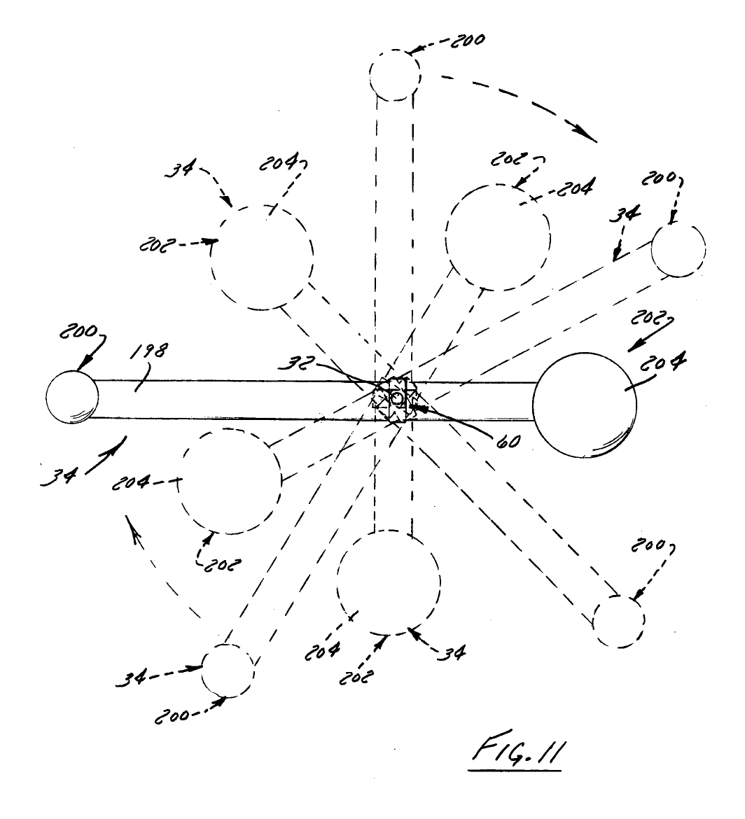

With additional reference to FIGS. 10 and 11, when the motor 228 is turned on, the motor 228 rotates the armature 232 such that the arm 262 of the armature 232 rotates the upper line 32 about the axis of rotation 264 of the motor output shaft 248 but offset by the distance, R, of the arm 262 causing the mobile arm 34 to spin in the counterclockwise direction shown in FIG. 10. During motor operation, the upper line 32 and hence the collar 206 rotates about the motor axis of rotation 264 with the upper line 32 and collar 206 orbiting about the motor rotation axis 264, such as in the manner depicted in FIG. 10, as a result of the upper line 32 being mounted to the armature 232 by an offset, R.

In a preferred method of operation, the motor 228 is configured to operate for a first period of time, T₁, causing the armature 232 to rotate about the motor axis 264 causing the upper line 32 and collar 206 to orbit the axis 264 spinning the mobile arm 34 (and plaything 36) in a counterclockwise direction as depicted in FIG. 10. During motor operation, orbiting of the upper line 32 and collar 206 about the motor rotational axis 264 causes at least the upper line 32 to twist and store potential rotational energy as a torsion spring as a result of the mass of the mobile arm 34 as well as the animal plaything 36 attached to the mobile arm 34 by lower line 40. During motor operation, the mass of the mobile arm 34 and plaything 36 causes at least the upper line 32 to twist due to the rotational inertia of the mobile arm 34 and plaything 36 causing them to lag behind rotation of the line 32, particularly where it attaches to the armature 232. During motor operation, the motor 228 rotates the armature 232 at least a plurality of pairs of times, i.e. at least three times, and preferably rotates the armature 232 substantially continuously during T₁.

With reference to FIG. 11, after the first period of time, T₁, has elapsed, the motor 228 pauses operation for a second period of time, T₂, allowing the potential energy that has built up in the upper line 32 to be converted to kinetic rotational energy causing the line 32 to function as a torsion spring that has been wound up. As the potential energy built up in the upper line 32 is released and converted into kinetic rotational energy, the line 30 to causes the mobile arm 34 and plaything 36 to stop spinning in the counterclockwise direction, come to a stop, and then begin spinning in a clockwise or opposite direction as depicted in FIG. 11. The mobile arm 34 and plaything 36 spin about the upper line 32 with the upper line 32 serving as an axis of rotation about which the mobile arm 34 and plaything 36 spin.

The mobile arm 34 and plaything 36 continue to spin about the upper line 32 until the second period of time, T₂, elapses after which the motor 228 resumes operation causing the upper line 32 to rotate offset about motor rotational axis 264 in the manner discussed in the preceding paragraph. In this preferred method, the motor 228 is alternately started, causing at least the upper line 32 to twist during motor operation storing potential rotational energy, and paused, causing the potential energy stored in the twisted upper line 32 to be converted into kinetic rotational energy that rotates the mobile arm 34 and animal plaything 36 about the line 32 in a direction opposite that of the motor 228. Motor 228 can be configured with a timer 268, such as by including a 555 timer circuit or the like onboard the motor 228 or disposed within the drive housing 220. Other arrangements, configurations and/or circuits provide such alternate stopping and pausing of the motor 228 can be employed.

In a preferred method of operation, the motor 228 is alternately operated for an operational period, T₁, of twenty seconds and then paused for a period, T₂, of twenty seconds. While operation of the motor 228 can be alternated so it is turned on for twenty seconds and then turned off for twenty seconds indefinitely, the timer 268 can be configured to turn the motor 228 after a period of time has elapsed, such as 15 minutes, to conserve battery life. If desired, the duration of the operational period can be more or less than twenty seconds. If desired, the duration of the period which the motor is paused can also be more or less than twenty seconds.

In another preferred method of operation, the motor 228 is configured to sense the absence of interaction of the cat 48 with the mobile 22 and shuts the motor 228 off after a certain predetermined period of time after which no animal interaction activity is detected. For example, motor current can be monitored to detect such animal interaction activity or lack thereof in determining when to shut off the motor 228 after the predetermined period of time of no animal interaction activity elapses. In another implementation of such a method of shutting down the motor 228 after the predetermined period of time of no animal interaction activity occurs, a sensor (not shown) in communication with the motor 228 and/or mobile 22, e.g., upper line 32, mobile arm 34, lower line 40, and/or animal plaything 36, can be employed in monitoring animal interaction activity.

In use and operation, the motor 228 is alternately operated and paused causing the mobile arm 34, lower line 40, and animal plaything 36 to orbit and spin around the motor rotational axis 264 enticing an animal 42, preferably a cat 48, into interacting with the animal plaything 36. As a result of the construction of the mobile 22, batting of the animal plaything 36 by the cat 48 sends feedback through the lower line 40, mobile arm 34, upper line 32, boom 28 as well as the mounting bracket 68 with the resultant feedback causing potential energy to be alternately stored and released in a manner that causes the animal plaything 36 to leap and dance unpredictably in a manner that simulates live prey. Likewise, grasping of the animal plaything 36 by the cat 48 pulling down the animal plaything 36 also sends feedback throughout the entire mobile 22 and can cause the animal plaything 36 to be pulled free of the cat 48 due to spring back of the lower line 40 and upper line 32 being pulled taut by the cat 48 grasping the plaything 36. When this happens, the lower line 40, upper line 32, boom 28 and/or mount 26 function as tensile springs that can stretch, store potential energy, and then convert the potential energy into kinetic energy pulling the animal plaything 36 free of the cat 48 as well as causing the animal plaything 36 to randomly leap and dance in an enticing manner.

It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention.

It is claimed:

1. An animal entertainment device comprising an animal plaything carried by an arm.

2. The animal entertainment device of claim 1 further comprising a mount removably mounting the animal entertainment device to a door having oppositely extending door handles and a pair of straps wrapped around a respective one of the door handles attaching the mount to the door.

3. The animal entertainment device of claim 2, wherein each one of the straps is comprised of a hook and loop fastener material.

4. The animal entertainment device of claim 3, wherein each strap has a plurality of outer surfaces with one of the surfaces comprised of hook material having a plurality of hooks and another one of the surfaces comprised of loop material having a plurality of loops.

5. The animal entertainment device of claim 4, wherein the each strap comprises a ribbon having a pair of opposed surface with one of the surfaces on one side of the strap comprised of hook material extending substantially the length of the strap and the other one of the surfaces on the other side of the strap comprised of loop material extending substantially the length of the strap.

6. The animal entertainment device of claim 2, wherein the mount comprises a U-shaped mounting bracket seating on an outer edge of the door.

7. The animal entertainment device of claim 6, wherein the mounting bracket comprises (a) an endwall abutting the outer edge of the door and (b) a pair of generally parallel flanges extending outwardly from the endwall defining a channel in which the door is received with one of the flanges extending along one side of the door and the other one of the flanges on the other side of the door.

8. The animal entertainment device of claim 1 further comprising a boom attached to a bracket by a coupling comprised of a plurality of engagement surfaces with one of the engagement surfaces generally transverse to another one of the engagement surfaces.

9. The animal entertainment device of claim 8, wherein the coupling comprises (a) a first one of a first pair of engagement surfaces of one of the boom and bracket that overlies a second one of the pair of engagement surfaces of the other one of the boom and bracket and (b) a first one of a second pair of engagement surfaces of one of the boom and bracket that is annular and a second one of the second pair of engagement surfaces of the other one of the boom and bracket that is annular and generally complementary with the first annular surface of the second pair of engagement surfaces.

10. The animal entertainment device of claim 9, wherein the first and second annular surfaces of the second pair of engagement surfaces is generally transverse to the first and second surfaces of the first pair of engagement surfaces.

11. The animal entertainment device of claim 10 further comprising a fastener joining the boom to the bracket.

12. The animal entertainment device of claim 8, wherein the coupling comprises a ball and socket coupling arrangement with one of the boom and bracket comprising a ball and the other one of the boom and bracket comprising a socket.

13. The animal entertainment device of claim 12, wherein one of the ball and socket comprises a plurality of spaced apart channels and the other one of the ball and socket comprising a finger received in one of the channels retaining the boom in one of a plurality of angular positions relative to the bracket.

14. The animal entertainment device of claim 13, wherein the ball and socket coupling arrangement comprises an annular projection extending outwardly from one of the ball and socket and an annular recess formed in the other one of the ball and socket that receives the annular projection.

15. The animal entertainment device of claim 14, wherein the annular projection and an annular recess comprise a pin and bore interlocking arrangement.

16. The animal entertainment device of claim 15, wherein the boom comprises a tube with an end cap comprising the ball and the bracket comprises a socket formed therein and further comprising a fastener interconnecting the bracket and the ball.

17. The animal entertainment device of claim 1, further comprising a boom, a first line extending downwardly from the boom to the arm, and a second line extending from the arm to the animal plaything.

18. The animal entertainment device of claim 17, wherein the arm is elongate having a counterweight disposed outwardly of a point of attachment of the first and second lines.

19. The animal entertainment device of claim 18, wherein one of the lines is adjustably attached to the arm.

20. The animal entertainment device of claim 19, wherein one of the lines is slidably adjustably attached to the arm by a collar that is slidable along the arm.

21. The animal entertainment device of claim 17, further comprising a drive carried by the boom having a rotary armature from which the first line that is offset from a rotational axis of the armature.

22. The animal entertainment device of claim 21, wherein the first line comprises a torsion spring and the drive is configured to alternately (a) rotate the armature and first line spinning the arm, the second line and the animal plaything in one direction about the rotational axis of the armature causing rotational energy to be stored by the first line and (b) pause rotation of the armature releasing rotational energy stored by the first line causing the arm, the second line and the animal plaything to spin an opposite direction about the first line.

23. The animal entertainment device of claim 1, further comprising a boom that comprises a first spring, a first line extending downwardly from the boom to the arm that comprises a second spring, and a second line extending from the arm to the animal plaything.

24. The animal entertainment device of claim 23, further comprising a mounting bracket comprising a third spring and wherein the animal plaything comprises a first mass and the arm comprises a second mass.

25. The animal entertainment device of claim 23, further comprising a mounting bracket attached to a pair of opposed door handles by a pair of flexible straps that wrap around the door handles with one of the flexible straps wrapping around one of the door handles and the other one of the flexible straps wrapping around the other one of the door handles.

26. The animal entertainment device of claim 1, further comprising a mounting bracket having a plurality of flexible elongate door knob engaging straps, a boom cantilevered outwardly from the mounting bracket, a first elongate flexible line extending from the boom to the arm, and a second elongate flexible line extending from the arm to the animal plaything.

27. The animal entertainment device of claim 26, further comprising a drive carried by the boom having an armature with the first line attached to the armature offset from an armature axis of rotation.

28. The animal entertainment device of claim 27, wherein the animal entertainment device comprises a mobile.

29. A method of operating an animal entertainment device comprising:
(a) providing a boom carrying a drive having a rotary armature from which a first line comprising a torsion spring downwardly extends carrying an arm from which a second line extends carrying an animal plaything;
(b) rotating armature for a first period of time rotating the arm, second line and animal plaything in one direction storing rotational potential energy in the first line;
(c) pausing rotation of the armature for a second period of time for enough time to allow conversion of the stored potential energy in the first line to be converted to kinetic energy rotating the arm, second line and animal plaything in an opposite direction; and
(d) utilizing the converted kinetic rotational energy of the first line to rotate the arm, second line and animal plaything in the opposite direction.

30. The method of claim 29 wherein the first line is attached to the armature a distance from an axis of rotation of the armature wherein the first line orbits the axis of rotation of the first line during step (b) and wherein the arm, second line and animal plaything rotate about the first line during step (d).

31. The method of claim 30 comprising repeating steps (a)-(d).
